(19) United States
(12) Patent Application Publication
(10) Pub. No.: US 2019/0055987 A1
(43) Pub. Date: Feb. 21, 2019

(54) METHOD FOR PRODUCING A MULTI-LAYER PLAIN BEARING

(71) Applicant: Miba Gleitlager Austria GmbH, Laakirchen (AT)

(72) Inventor: Georg LEONARDELLI, Laakirchen (AT)

(73) Assignee: Miba Gleitlager Austria GmbH, Laakirchen (AT)

(21) Appl. No.: 16/025,202

(22) Filed: Jul. 2, 2018

(30) Foreign Application Priority Data
Aug. 18, 2017 (AT) GM 50155/2017

(51) Int. Cl. F16C 33/12; B05D 3/06

(52) U.S. Cl. CPC F16C 33/125; F16C 2204/12; B05D 3/06; F16C 33/121

(57) ABSTRACT

The invention relates to a method for producing a multi-layer plain bearing element with a first layer made from a metal having an inner face, whereby this inner face is cleaned by scanning the entire inner face by means of a laser and at least one other layer is then applied to the inner face of the first layer. The cleaning is carried out using an ultrashort pulse laser.

The invention relates to a method for producing a multi-layer plain bearing element with a first layer made from a metal having an inner face, whereby this inner face is cleaned by scanning the entire inner face by means of a laser and at least one other layer is then applied to the inner face of the first layer.

Many types of multi-layer plain bearings and methods for producing them have been described in the prior art. The simplest case is that of two-layer bearings where an anti-friction layer is applied to a supporting layer. However, other designs with more than two layers are also known.

When producing these multi-layer plain bearings, forming processes and associated mechanical machining of surfaces such as precision boring or broaching are often necessary to enable predefined geometries of the multi-layer plain bearing to be obtained. This also applies to the supporting layer, the so-called backing metal layer. The latter is often made from steel, although other materials such as bronze materials may also be used.

To protect the tools as far as possible, improve clamping accuracy to prevent damage to components or to improve the bond strength of the layers joined to one another, impurities from previous processing steps, including grease and oils, must be removed from surfaces. Solvents may be used for this purpose and are often applied manually by means of appropriate cloths. However, these cleaning methods are problematic due to the very low process quality caused by cloths that very rapidly become soiled and thus reduce the cleaning effect. Solvents are problematic as such, not least from a health point of view.

More reliable cleaning of a surface that is to be coated is possible using a removal process. As with chemical cleaning, however, this mechanical cleaning also leads to contamination and dispersion of material and impurities. Not only can this in turn reduce the adhesive strength of the coating to be applied to this surface, it can also become a source of corrosion, especially if these contaminants are embedded in the cleaned layer. This can occur due to the fact that the surface to be coated has to be partially melted.

The objective of this invention is to propose an improved cleaning method for producing multi-layer plain bearings.

The objective of the invention is achieved by the aforementioned method due to the fact that cleaning is carried out using an ultrashort pulse laser.

The advantage of this is that cleaning of the inner face of the first layer can be carried out whilst ensuring constant quality and a high reliability that there will be no melting because using an ultrashort pulse laser means that relatively little energy is introduced into the surface regions respectively being subjected to cleaning. Accordingly, no individual holes with melted edges are created. Since the grease and oils are evaporated, there is also no longer any need for solvents so that no residues of solvent are left on or in the first layer. In particular, using an ultrashort pulse laser also means that structural changes caused by the introduction of heat into the first layer are better prevented. Cleaning can therefore be carried out more easily by machine without altering the structure of the first layer.

Based on one embodiment of the method, a copper-based alloy, in particular a bronze, may be used as the first layer. Copper-based alloys, such as bronzes in particular, exhibit a pronounced reflection behavior, which until now has made the use of a laser for cleaning the surface of a layer of a multi-layer plain bearing element problematic, if not at least impossible to some extent. By using an ultrashort pulse laser, the problems associated with cleaning surfaces of copper-based alloys by laser do not occur or are not very prevalent, namely that they are exposed to the laser radiation for a relatively long time which significantly increases the risk of melting in some surface regions.

Based on another embodiment of the method, the inner face is preferably roughened to create a micro-geometry at the same time as it is being cleaned. Due to the roughening, in other words the removal of material, the quality of the surface cleaning can be further increased. At the same time, however, a surface can also be produced that will enable improved adhesion of the layer to be deposited on it to be obtained.

To further improve these effects, in particular to increase the adhesive strength of the other layer on the first layer, other embodiments may be such that the micro-geometry is produced with an arithmetic mean roughness Ra in accordance with DIN EN ISO 4287:2010 of between 30 nm and 1 μm and/or the micro-geometry is produced with an average peak-to-valley height Rz in accordance with DIN EN ISO 4287:2010 of between 200 nm and 5 μm with a maximum single roughness depth Rmax in accordance with DIN EN ISO 4287:2010 of between 200 nm and 5 μm.

Based on another embodiment of the method, the cleaning process can be implemented by scanning the inner face of the first layer by means of the laser in lines in processing paths and the processing paths overlap one another. The overlap of the laser points further increases the process reliability.

Based on another embodiment of the method, cleaning of the inner face of the first layer is implemented at a distance from the laser which corresponds to the focal length of the laser. Not only does this improve the energy efficiency of the surface cleaning, it also enables the aforementioned micro-geometry to be more effectively produced because tracks can be created on the inner face of the first layer by means of the laser, for example in the form of a pattern based on the linear scanning operation.

As an additional layer, it is particularly preferable to apply an anti-friction lacquer coating to the first layer. It is particularly with such layers that the advantages of the method pay off because the durability of polymer layers which are more susceptible to wear than metal layers can be improved.

To provide a clearer understanding, the invention will be explained in more detail in the description below.

Firstly, it should be pointed out that the positions chosen for the purposes of the description, such as top, bottom, side, etc., relate to the embodiment of the multi-layer plain bearing element specifically being described and can be applied in terms of meaning to a new position when another position is being described.

The multi-layer plain bearing element may be provided in the form of a half shell, in which case it forms a plain bearing in conjunction with at least one other plain bearing element in a manner known per se. It is also possible for the multi-layer plain bearing element to be provided in the form of a plain bearing bush (in which case the multi-layer plain bearing element is simultaneously the plain bearing) or a thrust ring. Another option is one based on a different split, for example a three-way split so that the multi-layer plain bearing element is combined with two other plain bearing elements to form a plain bearing, and at least one of the two other plain bearing elements may likewise be formed by the multi-layer plain bearing element. In this case, the multi-layer plain bearing element does not cover an angular range of 180° but an angular range of 120°. Another option, however, is one where at least one of the at least one other plain bearing elements is formed by the multi-layer plain bearing element.

In particular, the multi-layer plain bearing element is intended for use in the automotive industry and/or in engines.

A multi-layer plain bearing element that is being cleaned by the method proposed by the invention during the course of its production has at least one first layer and at least one other layer.

It should already be noted at this stage that the term “cleaning” should be construed as meaning both the removal of at least one grease as such and the removal of at least one oil as well as other contaminants, for example solvent. The greases and oils are those which are used as standard in the production of multi-layer plain bearing elements.

In addition, any dirt there might be can optionally also be removed. This dirt might also be in the form of typical deposits of processing fluids from previous processing steps. In this context, processing fluids also include, but are not limited to, cooling lubricant, machining oils, drilling emulsions, etc. The deposits may also be of a salt-based or other solid type.

The first layer is the supporting layer of a multi-layer plain bearing element in particular. As a rule, this is the radially outermost first layer of a radial plain bearing.

The other layer is the anti-friction layer in particular in the case of a two-layer or multi-layer plain bearing element. The anti-friction layer is the layer which sits in contact with the component to be mounted during operation, namely a shaft in particular, provided no additional so-called flash has been applied for the purpose of running in the multi-layer plain bearing for example.

It should be pointed out, however, that the first layer may also be formed by another layer of a multi-layer plain bearing element, for example a so-called bearing metal layer.

In any case, the other layer is deposited directly on the first layer of the multi-layer plain bearing element.

The supporting layer forms the so-called backing metal which faces a bearing seat in which the multi-layer plain bearing element is accommodated during operation. In the case of multi-layer plain bearing elements based on a shell design, this backing metal layer normally forms the radially outer layer, provided no anti-fretting layer has been applied for the purpose of preventing damage to a plain bearing due to micro-movements between the bearing seat and the multi-layer plain bearing element.

The supporting layer may be made from a steel. However, other known metal materials may be used. The supporting layer or generally the first layer is preferably formed by a copper-based alloy, in particular a bronze.

However, the first layer may also be produced from an aluminum alloy.

Based on another preferred embodiment of the method, the other layer is produced from an anti-friction lacquer. An anti-friction lacquer in this context should be construed as meaning a lacquer containing a solvent (mixture), at least one precursor for a polymer and at least one solid lubricant and optionally reinforcing agent. This is applied to the first layer and a solid layer with anti-friction properties is produced from it by drying and polymerization, in particular at a raised temperature.

A polyimide, in particular a polyamide imide, is preferably produced as the polymer. As solid lubricants, it is preferable to use graphite and MoS₂. The reinforcing agent may be particulate, for example oxides or mixed oxides, in particular bismuth vanadate, chromium antimony rutile or mixtures thereof.

However, other known anti-friction lacquers may also be used.

The multi-layer plain bearing element may also have more than two layers. For example, said bearing metal layer and/or at least one binder layer and/or at least one diffusion barrier layer may be provided between the supporting layer and the anti-friction layer.

The metal materials which may be used in multi-layer plain bearing elements for the anti-friction layer, bearing metal layer, binder layer and diffusion barrier layer are known from the prior art, to which reference may be made for more details.

The method for producing a multi-layer plain bearing element is also known from the prior art as such. In this context, a distinction may be made between two methods. Based on a first one, a flat substrate is produced from the material for the supporting layer and the anti-friction layer is provided on top of it, optionally with at least one intermediate layer provided in between (in particular at least one of those mentioned above), thereby creating the composite material. Classical methods used for this purpose are roll cladding, cast cladding, sintering. The multi-layer plain bearing element is then shaped from this blank by a forming process.

In addition, there are also methods whereby the blank is formed before applying the material for the anti-friction layer. These include, for example, galvanic deposition and PVD methods, e.g. sputtering.

Another option is for the supporting layer to be formed by the component itself, for example a connecting rod, in particular in the region of its connecting rod big end. In this case, the anti-friction layer is applied by directly coating the connecting rod big end.

With all of the methods, a mechanical machining process may be necessary during the course of producing the multi-layer plain bearing element to enable the desired or requisite geometry to be obtained with the smallest tolerances possible. Usually, this will for the most part involve process steps to remove material, such as precision boring or slotting-broaching, for example. Coolants in the form of oils or liquids containing oil are used during these mechanical machining processes in order to protect the tools from overheating and thus increase the service life of the tools.

The materials for the individual layers and/or the composite materials comprising them may also come into contact with grease in the machines during the process of producing the multi-layer plain bearing element.

The greases and oils as well as dirt generally then have to be removed again. This applies in particular to the inner face of the supporting layer (or more generally the first layer) before another layer is applied.

The inner face is generally the radially inner surface or the surface of a layer of a multi-layer plain bearing element that sits closer to a component to be mounted.

An ultrashort pulse laser is used to clean the inner face of the first layer. This is a laser radiation source which emits pulsed laser light with pulse durations in the range of picoseconds to femtoseconds or in the range of picoseconds to attoseconds or in the range of femtoseconds to attoseconds. The pulse duration is therefore less than 1 ns.

The inner face can be cleaned after a machining process to remove material and before another mechanical machining operation, in particular to remove the chippings (which occur during precision boring, for example). The chippings are preferably removed using brushes. In particular, the brushing process takes place exclusively after degreasing so that fewer chippings remain adhered to the brushes.

In order to clean the corresponding surface of the multi-layer plain bearing element (within the meaning of the invention, this should also be construed as being a preliminary stage of the finished multi-layer plain bearing element), the laser is passed across the entire inner face of the first layer (or supporting layer) so that the laser passes across every point of this surface at least once during the course of cleaning.

The surface may be scanned by the laser in lines in the form of a dot matrix pattern. In this context, it is of advantage if the focal point of the laser lies on the surface to be cleaned, to which end the distance between the surface to be cleaned and the laser corresponds to the focal length. The laser therefore hits the surface with a dot matrix pattern.

However, the surface to be cleaned may also lie outside the focal point of the laser, to which end the distance between the surface and the laser is smaller than or greater than its focal length. As a result, the laser radiation hits the surface in the shape of a circle or ellipsis, depending on the position which the laser assumes relative to the surface.

Accordingly, the distance between the surface and the laser (i.e. the exit of the light beam from the laser) may be smaller or greater than the focal length by a value selected from a range of 0.5 mm to 20 mm, in particular from a range of 2 mm to 5 mm.

In particular, the distances of the dots or circles of the dot matrix pattern are selected so that the areas scanned by the laser with each pulse adjoin one another or preferably overlap one another.

Furthermore, the distance between the laser and the surface to be degreased may be selected so that the focal point lies below and hence outside the first layer.

The process of cleaning by laser may be operated without removing any of the metal from which the first layer is made. Furthermore, the laser cleaning process may be operated so that no change in the structure of the supporting layer takes place. In addition, cleaning may also be operated in such a way that no bonding with a component of the material of the first layer, such as oxides for example, is removed by the laser.

Based on a preferred variant of the method, at the same time as the inner face of the first layer is being cleaned, it is roughened to create a micro-geometry, to which end a corresponding amount of material is removed from the surface of the first layer.

The micro-geometry is preferably produced with an arithmetic mean roughness Ra in accordance with DIN EN ISO 4287:2010 of between 30 nm and 1 μm, preferably between 30 nm and 70 nm, and/or with an average peak-to-valley height Rz in accordance with DIN EN ISO 4287:2010 of between 200 nm and 5 μm, preferably between 200 nm and 350 nm, with a maximum single roughness depth Rmax in accordance with DIN EN ISO 4287:2010 of between 200 nm and 5 μm. Naturally, Rmax may not be less than Rz.

Laser pulses are used to implement the cleaning operation, and the number of pulses is preferably high and the pulse duration selected so that it is short, thereby enabling thermal stress to the surface to be cleaned to be prevented. The pulse frequency may vary between 10 kHz and 1 MHz. The power per unit area depends on pulse frequency and the distance of the individual laser points from one another on the surface to be degreased (the size of the laser points may be between 50 μm and 300 μm). For example, at 35 W output power of the laser, the max. pulse energy is ca. 175 μJ and the power per unit area ca. 3 J/cm² (pulse frequency 200 kHz, pulse duration 1 ps).

It is also preferable if the pulse intensity and the pulse duration of the laser are kept constant during the entire process of cleaning the surface.

Based on one embodiment, the cleaning process may be implemented by scanning the inner face of the first layer in lines by means of the laser in processing paths, and the processing paths overlap one another. The overlap range is selected from 1% to 50% of the width of a processing path. The processing paths are preferably all of the same width.

The examples of embodiments describe possible variants of the method and combinations of the individual variants with one another are also possible.

1. A method for producing a multi-layer plain bearing element with a first layer made from a metal having an inner face, whereby this inner face is cleaned by scanning the entire inner face by means of a laser and at least one other layer is then applied to the inner face of the first layer, wherein the cleaning is carried out using an ultrashort pulse laser.

2. The method according to claim 1, wherein a copper-based alloy, in particular a bronze, is used as the first layer.

3. The method according to claim 1, wherein the inner face is roughened to create a micro-geometry at the same time as it is being cleaned.

4. The method according to claim 3, wherein the micro-geometry is produced with an arithmetic mean roughness Ra in accordance with DIN EN ISO 4287:2010 of between 30 nm and 1 μm.

5. The method according to claim 1, wherein the micro-geometry is produced with an average peak-to-valley height Rz in accordance with DIN EN ISO 4287:2010 of between 200 nm and 5 μm with a maximum single roughness depth Rmax in accordance with DIN EN ISO 4287:2010 of between 200 nm and 5 μm.

6. The method according to claim 1, wherein the cleaning process is implemented by scanning the inner face of the first layer by means of the laser in lines in processing paths and the processing paths overlap one another.

7. The method according to claim 1, wherein cleaning of the inner face of the first layer is implemented at a distance from the laser which corresponds to the focal length of the laser.

8. The method according to claim 1, wherein an anti-friction lacquer coating is applied as the other layer.
